(19) United States
(12) Patent Application Publication
(10) Pub. No.: US 2025/0137371 A1
(43) Pub. Date: May 1, 2025

(54) CAM PROFILE DRIVE ASSEMBLY

(71) Applicant: ZPE LTD, Bristol (GB)

(72) Inventors: Keith Nair, Bristol (GB); Daniel Spokes, Newent Gloucestershire (GB)

(21) Appl. No.: 18/681,734

(22) PCT Filed: Aug. 9, 2022
(86) PCT No.: PCT/EP2022/072356

§ 371 Date: Feb. 6, 2024

(30) Foreign Application Priority Data
Aug. 13, 2021 (GB) 2111558.6
Aug. 13, 2021 (GB) 2111670.2

(51) Int. Cl. F01B 3/02

(52) U.S. Cl. CPC F01B 3/02

(57) ABSTRACT

Aspects of the present invention relate to a swash plate drive assembly (15-n) for a swash plate engine (3). The swash plate drive assembly (15-n) includes a carriage body (19) for reciprocating along a longitudinal axis (X-n). At least one piston (5-n) is providing for displacing the carriage body (19) along a longitudinal axis (X-n). The at least one piston (5-n) has a connecting rod (13-n) releasably fastened to the carriage body (19) by one or more mechanical fastener (17-n). Aspects of the present invention also relate to a connecting rod (13-n), and a swash plate engine (1).

### TECHNICAL FIELD

The present disclosure relates to a drive assembly. The drive assembly is suitable for a swash plate engine. More particularly, but not exclusively, the drive assembly comprises a swash plate drive assembly for a swash plate engine. The swash plate engine may be an axial piston, swash plate engine. Aspects of the invention relate to a swash plate drive assembly for a swash plate engine; a connecting rod for a swash plate engine; and a swash plate engine.

### BACKGROUND

Swash plate engines utilise an angled disc to convert the linear axial motion of pistons into rotary motion. The rotary motion may, for example, comprise rotating a drive shaft. If the load is transferred via a yoke style roller bearing, the rolling bearings may be subjected to high operating load. In order to remove, replace or adjust the rolling bearings, current designs may require that the entire engine casing is dismantled, and the piston carriage removed. Similarly, if the piston rings need to be replaced the entire engine typically needs to be disassembled. At least in certain known arrangements, the rolling bearings cannot readily be adjusted, or compensation made for wear.

It is an aim of the present invention to address one or more of the disadvantages associated with the prior art.

### SUMMARY OF THE INVENTION

Aspects and embodiments of the invention provide a swash plate drive assembly for a swash plate engine; a connecting rod for a swash plate engine; and a swash plate engine as claimed in the appended claims.

According to an aspect of the present invention there is provided a swash plate drive assembly for a swash plate engine, the swash plate drive assembly comprising:
a carriage body for reciprocating along a longitudinal axis; and
at least one piston for displacing the carriage body along the longitudinal axis;
wherein the at least one piston is connected to a connecting rod, the connecting rod being releasably fastened to the carriage body by one or more mechanical fastener. The one or more mechanical fastener can be selectively fastened and unfastened to connect the connecting rod to the carriage body. One or more mechanical fastener may be used to fasten the connecting rod to the carriage body. At least in certain embodiments, a single mechanical fastener may be used to fasten the connecting rod to the carriage body. At least in certain embodiments, the swash plate drive assembly is configured to enable the carriage body to be disconnected from the connecting rod without requiring that the at least one connecting rod is removed from the swash plate engine. This may enable the carriage body to be removed by releasing the at least one mechanical fastener. The carriage body may be extracted from the swash plate engine, for example through a portal or an aperture formed in a housing of the swash plate engine. The swash plate drive assembly may thereby facilitate servicing and/or maintenance of the swash plate engine.

The at least one connecting rod may comprise at least one locating member. The at least one locating member may be configured to fix the longitudinal position of the connecting rod relative to the carriage body. The at least one locating member may be configured to engage the carriage body when the connecting rod is releasably fastened to the carriage body. The at least one locating member may extend at least partway around a circumference of the connecting rod. The at least one locating member may form a collar on the connecting rod. The collar may extend around the circumference of the connecting rod. The at least one locating member may be formed integrally with the or each connecting rod. Alternatively, the at least one locating member may be mounted to the or each connecting rod.

The mechanical fastener may be configured to engage the at least one locating member provided on the connecting rod. The at least one locating member may be disposed between the carriage body and the mechanical fastener. The at least one locating member may be clamped or held between the carriage body and the mechanical fastener. At least in certain embodiments, movement of the connecting rod relative to the carriage body may be prevented or limited.

The mechanical fastener may comprise one or more shoulder. The one or more shoulder may engage the at least one locating member provided on the connecting rod. The engagement of the at least one locating member may inhibit or limit movement of the connecting rod relative to the carriage body.

The at least one locating member may extend in a radial direction. The at least one locating member may comprise an end face disposed in a plane at least substantially perpendicular to the longitudinal axis. The end face of the locating member may abut the carriage body.

The or each mechanical fastener may comprise a rotary fastener for releasably fastening the connecting rod to the carriage body. The rotary fastener may be rotatable about a central axis. The rotary fastener may comprise a nut, such as a tie nut. The rotary fastener may be rotatable about the longitudinal axis of the swash plate drive assembly. The longitudinal axis may be coincident with a central longitudinal axis of the connecting rod.

The rotary fastener may comprise an annular member having a central aperture. The central aperture may extend through the rotary fastener. The connecting rod may locate in the central aperture. The rotary fastener be rotated about the connecting rod.

The rotary fastener may comprise an internal thread for cooperating with an external thread formed on the carriage body.

The rotary fastener may comprise at least one pair of opposing faces for cooperating with a wrench or similar tool to apply a torque to the mechanical fastener. The application of a torque may rotate the mechanical fastener selectively to fasten or unfasten the mechanical faster. The rotary fastener may, for example, comprise a square or hexagonal profile (in transverse section) for cooperating with a wrench.

A distal end of the or each piston may be disposed in an aperture formed in the carriage body. The aperture may extend along the longitudinal axis.

The swash plate drive may comprise at least one bearing assembly for engaging a swash plate in the swash plate engine.

The connecting rod may be releasably connected to the piston. A mechanical fastener may be provided for connecting the connecting rod to the piston. The connecting rod may comprise a threaded section for receiving a nut to connect the connecting rod to the piston.

The at least one piston may comprise first and second pistons. The first and second pistons may be connected to first and second connecting rods respectively. The first and second connecting rods may be releasably connected to the carriage body. The first and second connecting rods may be connected to opposite sides of the carriage body. The first connecting rod may be connected to a first side of the carriage body and the second connecting rod may be connected to a second side of the carriage body.

The first and second connecting rods may be releasably connected to opposite ends of the carriage body.

According to a further aspect of the present invention there is provided a swash plate engine comprising at least one carriage assembly as described herein. The swash plate engine may comprise a plurality of the carriage assemblies.

The at least one carriage assembly may be disposed in the housing.

The housing may comprise one or more aperture for accessing the at least one carriage assembly. One or more access panel may be provided to close the one or more aperture. The one or more access panel may be removable.

The one or more access aperture is sized to enable the carriage body to be removed from the swash plate engine through the access aperture.

According to a further aspect of the present invention there is provided a connecting rod for a swash plate engine, the connecting rod having a first end for connecting to a piston; and a second end for connecting to a carriage body of the swash plate engine;
wherein the connecting rod comprises at least one locating member for cooperating with a mechanical fastener releasably to fasten the connecting rod to the carriage body.

The at least one locating member may extend at least partway around a circumference of the connecting rod. The at least one locating member may comprise or consist of a collar.

The at least one locating member may comprise an end face for engaging the carriage body. The end face may be substantially planar. The end face may be disposed in a plane at least substantially perpendicular to a central longitudinal axis of the connecting rod.

The at least one locating member may be integrally formed with the connecting rod. Alternatively, the at least one locating member may be mounted to the connecting rod. A position of the at least one locating member along a longitudinal axis of the connecting rod may be adjustable. Alternatively, the at least one locating member may be mounted in a fixed position.

In use, a mechanical fastener may engage the at least one locating member to fasten the connecting rod to the carriage body. The at least one locating member may be held or clamped between the mechanical fastener and the carriage body.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a perspective view of a swash plate engine incorporating a plurality of carriage assemblies in accordance with an embodiment of the present invention;

FIG. 2 shows a longitudinal sectional view of the swash plate engine shown in FIG. 1;

FIG. 3 shows an enlarged view of a portion of the longitudinal sectional view shown in FIG. 2;

FIG. 4A shows a side view of a first swash plate drive assembly comprising a first carriage assembly and first and second axial pistons;

FIG. 4B shows a perspective view of the first swash plate drive assembly shown in FIG. 4A;

FIG. 5 shows a longitudinal sectional of a first one of the carriage assemblies in a first position relative to the carriage body;

FIG. 6 shows a longitudinal sectional of the first one of the carriage assemblies in a second position relative to the carriage body;

FIG. 7 shows a plan view of a variant of the yoke and bearing assembly used in the carriage assembly; and

FIG. 8 shows a sectional view along the section line A-A of FIG. 7.

### DETAILED DESCRIPTION

A swash plate engine 1 comprising a plurality of carriage assemblies 3-n in accordance with an embodiment of the present invention is described herein with reference to the accompanying Figures. The swash plate engine 1 in the present embodiment is an axial piston, swash plate engine. The swash plate engine 1 may be operable to drive an electric generator to generate electricity. Other applications are contemplated for the swash plate engine 1.

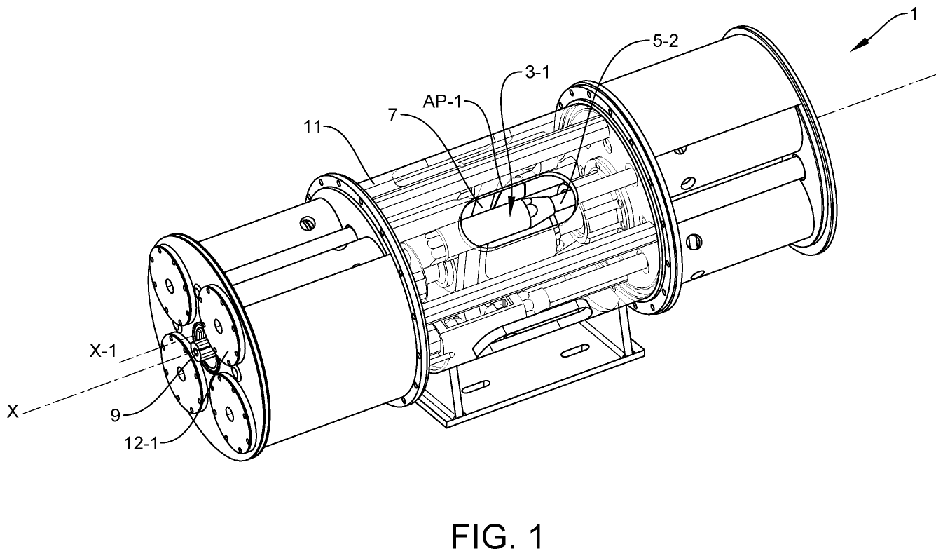

The swash plate engine 1 comprises a plurality of pistons 5-n, a swash plate 7 (also known as a slant disk or an angled disk), a drive shaft 9 and a housing 11. A perspective view of the swash plate engine 1 is shown in FIG. 1 with sections of the housing 11 shown partially transparent to facilitate understanding. The housing 11 is generally cylindrical in shape and has a central longitudinal axis X. The housing 11 comprises a plurality of cylinder heads 12-n removably mounted to an end plate. Each cylinder head 12-n is associated with a respective one of the pistons 5-n. The drive shaft 9 is rotatable about the central longitudinal axis X. The swash plate 7 is disposed at an oblique angle to the central longitudinal axis X. The swash plate engine 1 in the present embodiment comprises eight (8) pistons 5-n. The pistons 5-n are axial pistons each connected to a connecting rod 13-n arranged to reciprocate along a longitudinal axis X-n extending at least substantially parallel to the central longitudinal axis X. Each piston 5-n is disposed in a cylinder configured to form a combustion chamber in which a fuel is combusted. The fuel may, for example, be gasoline or diesel. Other types of fuel are also contemplated.

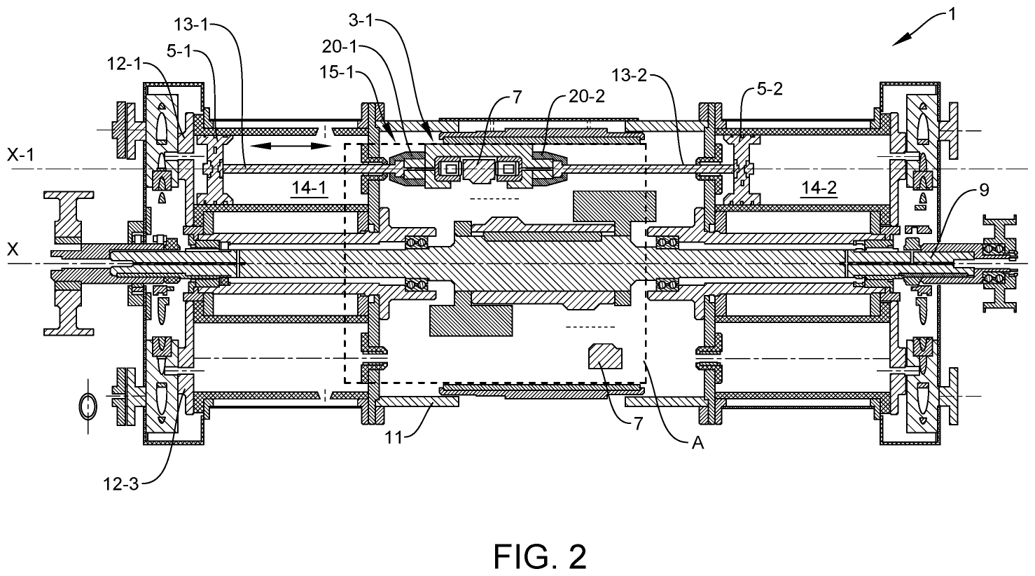

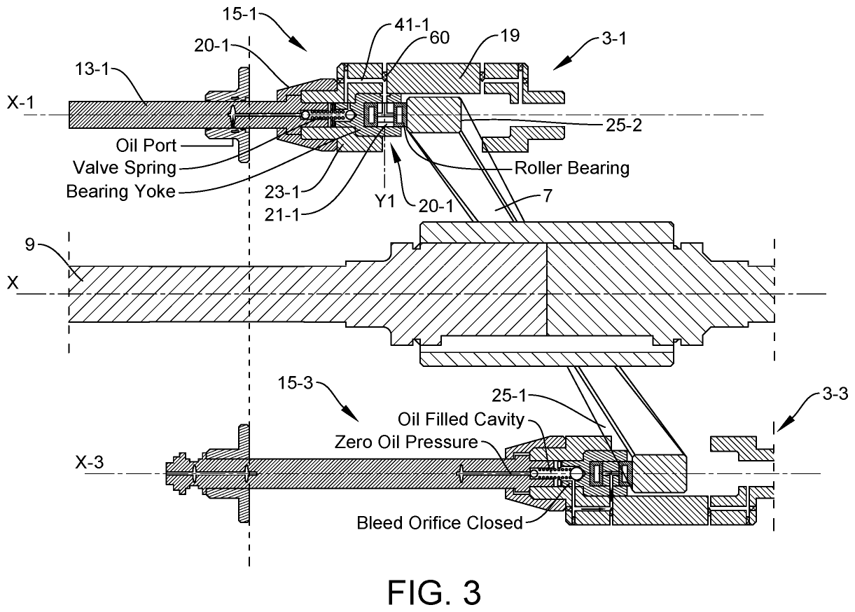

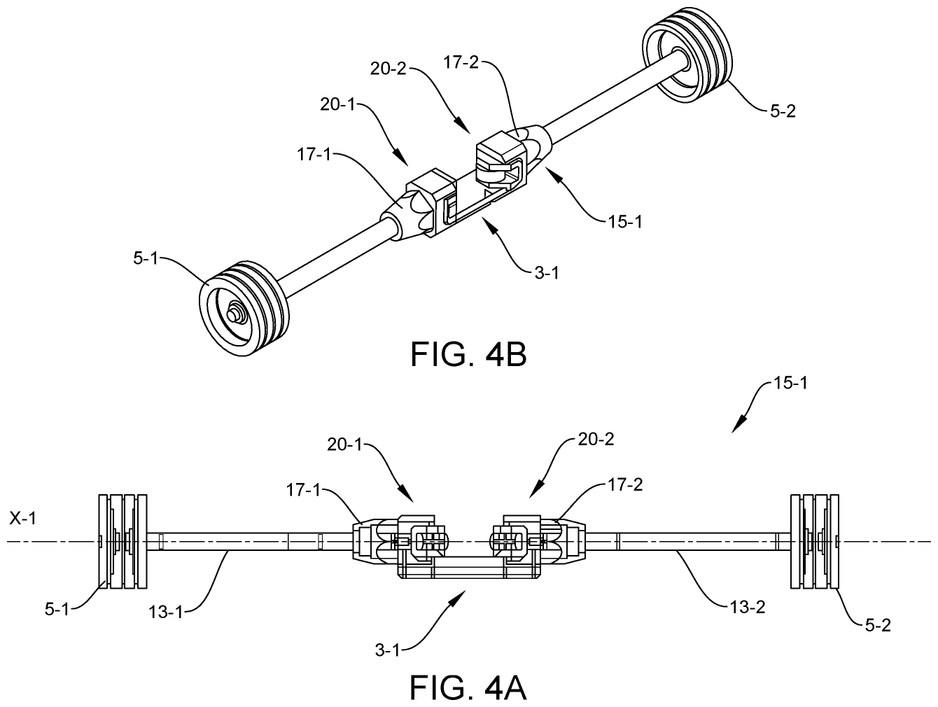

A longitudinal sectional view of the swash plate engine 1 is shown in FIG. 2. An enlarged view of the region labelled A in FIG. 2 is shown in FIG. 3. The carriage assemblies 3-n are configured to engage the swash plate 7. The carriage assemblies 3-n are configured to translate along the longitudinal axis X-n. The pistons 5-n are coupled to the carriage assemblies 3-n and, in use, drive the carriage assemblies 3-n. The pistons 5-n each reciprocate between a top dead centre (TDC) position and a bottom dead centre (BDC) position. The combination of each carriage assembly 3-n and one or more of the pistons 5-n forms a swash plate drive assembly 15-n. A first swash plate drive assembly 15-1 is shown in FIGS. 4A and 4B. In the present embodiment, the pistons 5-n are arranged in pairs comprising first and second pistons 5-1, 5-2 disposed on opposing first and second sides of the swash plate 7. Only the first and second pistons 5-1, 5-2 are shown in FIG. 2 for the sake of clarity. The first and second pistons 5-1, 5-2 are connected to opposite sides of the carriage assembly 3-n. The first and second connecting rods 13-1, 13-2 are connected to the first and second pistons 5-1, 5-2 respectively. The first and second connecting rods 13-1, 13-2 are fastened to the opposing sides of the carriage assembly 3-n. The first and second pistons 5-1, 5-2 are actuated to drive the carriage assembly 3-n along the longitudinal axis X-n in opposing first and second directions. The carriage assembly 3-n applies an axial force to the swash plate 7 which causes the drive shaft 9 to rotate. In use, the pistons 5-n are actuated sequentially to apply the axial force to the swash plate 7 to drivingly rotate the drive shaft 9.

In the present embodiment, the swash plate engine 1 comprises four (4) of the carriage assemblies 3-n. The carriage assemblies 3-n have a uniform angular separation (90°) in the present embodiment) around the circumference of the swashplate 7. As outlined above, the carriage assemblies 3-n are each connected to opposing first and second pistons 5-n. The carriage assemblies 3-n are arranged to reciprocate along the longitudinal axis X-n in unison with the first and second pistons 5-n. The carriage assemblies 3-n each support at least one bearing assembly 20-n. The carriage assemblies 3-n each have like configurations. A first one of the carriage assemblies 3-1 will now be described with reference to FIGS. 2 to 5.

The first carriage assembly 3-1 comprises a first carriage body 19, a first bearing assembly 20-1 and a second bearing assembly 20-2. The second bearing assembly 20-2 is omitted from FIG. 2 for clarity. The first and second bearing assemblies 20-1, 20-2 have like configurations. The first bearing assembly 20-1 comprises a first bearing 21-1 and a first yoke 23-1. The first bearing 21-1 is supported in the first yoke 23-1. The second bearing assembly 20-2 comprises a second bearing 21-2 and a second yoke 23-2. The second bearing 21-2 is supported in the second yoke 23-2. The first and second bearings 21-1, 21-2 are configured to engage opposing first and second rolling faces 25-n of the swash plate 7. The first and second bearings 21-1, 21-2 are configured to contact the first and second rolling faces 25-n respectively of the swash plate 7. The first bearing 21-1 comprises a first roller bearing (also known as a rolling bearing or a rolling-element bearing) rotatable about a first bearing axis Y-1; and the second bearing 21-2 comprises a second roller bearing (also known as a rolling bearing or a rolling-element bearing) rotatable about a second bearing axis Y-2. The first and second bearings 21-1, 21-2 each comprise an inner race, an outer race and a plurality of rolling elements. In use, the outer races of the first and second bearings 21-1, 21-2 directly engage the first and second rolling faces 25-n respectively. The outer race of the first and second bearings 21-1, 21-2 may comprise an outer profile which is cylindrical, part-cylindrical, part-spherical or spherical. The first and second bearing axes Y-1, Y-2 extend substantially parallel to each other in a radial direction substantially perpendicular to the first longitudinal axis X-1. The first and second bearings 21-1, 21-2 are configured to engage the first and second rolling faces 25-1, 25-2 respectively of the swashplate 7.

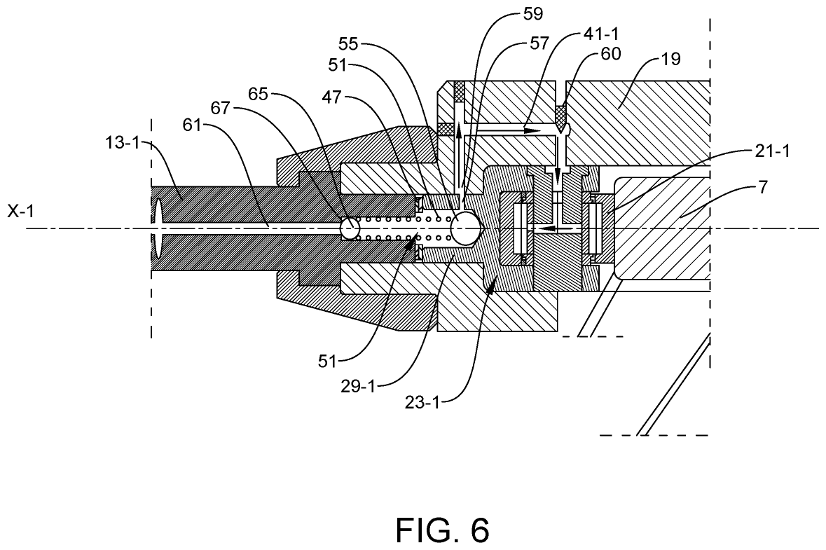

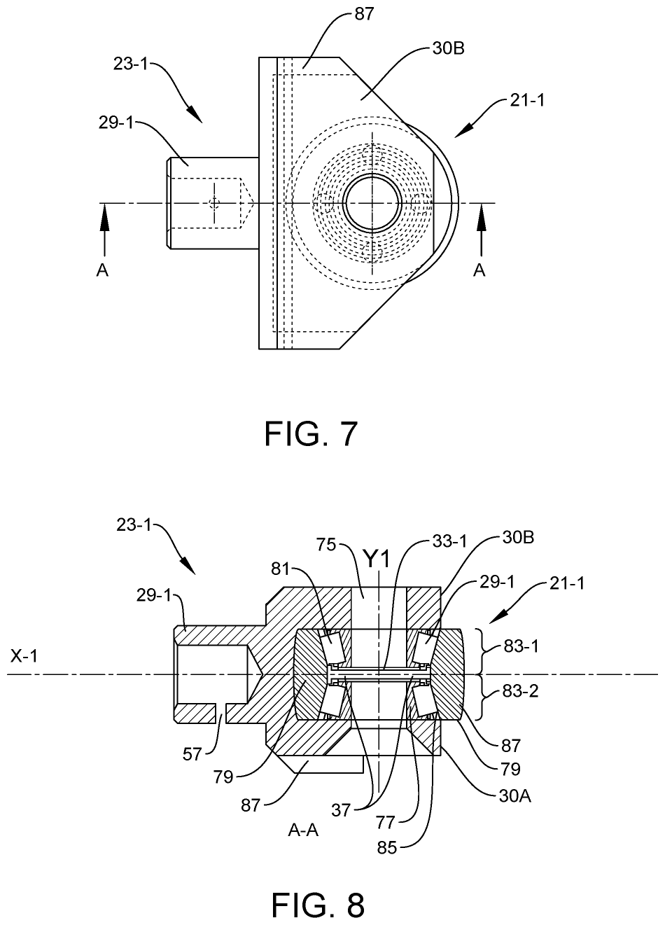

The first and second bearings 21-1, 21-2 are adapted to withstand the operating loads generated during operation of the swash plate engine 3. The first and second bearings 21-1, 21-2 in the present embodiment each comprise a yoke track roller. The outer race of each of the first and second bearings 21-1, 21-2 has an increased thickness (compared to a conventional bearing) to withstand higher operating loads, particularly loads applied in a radial direction. A plurality of needle rollers are disposed between the inner and outer races of the first and second bearings 21-1, 21-2. Other types of roller bearings may be employed. For example, the first and second roller bearings may comprise a cylindrical roller bearing, a spherical roller bearing or a needle roller bearing. A variant of the first and second bearings 21-1, 21-2 is described below with reference to FIGS. 6 and 7.

The first and second yokes 23-1, 23-2 are moveable relative to the first carriage body 19 along a longitudinal axis X-1. At least in certain embodiments, the movement of the first and second yokes 23-1, 23-2 relative to the first carriage body 19 may reduce the loading applied to the first and second bearings 21-1, 21-2. The configuration of the first yoke 23-1 will now be described with reference to FIGS. 3 and 4. It will be understood that the second yoke 23-2 has at least substantially the same configuration.

The first yoke 23-1 is moveable axially relative to the first carriage body 19 between a first position and a second position. The first position corresponds to a fully retracted position; and the second position corresponds to a fully advanced position. The first yoke 23-1 is in the fully retracted position when the first piston 5-1 is disposed in the top dead centre (TDC) position. The first yoke 23-1 is in the fully advanced position when the first piston 5-1 is disposed in the bottom dead centre (BDC) position. As shown in FIGS. 3 and 4, the first yoke 23-1 comprises a first bearing carrier 27-1 and a first plunger 29-1. The first bearing carrier 27-1 comprises first and second arms 30A, 30B in a Y-shaped configuration. The first bearing 21-1 is supported between the first and second arms 30A, 30B. In particular, the first and second arms 30A, 30B support a first bearing spindle 31-1 which defines the first bearing axis Y-1. The first bearing spindle 31-1 is hollow and comprises one or more bearing lubrication channel 33-1 operative to supply a lubricant to the first bearing 21-1. The bearing lubrication channel 33-1 comprises a first lubricant supply port 35-1 for receiving lubricant; and one or more first bearing outlet port 37-1. The or each first bearing outlet port 37-1 may comprise an aperture formed in the inner race of the first bearing 21-1 to facilitate lubrication of the rolling elements. As described herein, the first lubricant supply port 35-1 is in communication with a first gallery 41-1 formed in the carriage body 19. The first plunger 29-1 has a circular cross-section and is configured to enable axial movement of the first yoke 23-1 relative to the first carriage body 19. The first plunger 29-1 locates in a first aperture 43-1 formed in the first carriage body 19. The first aperture 43-1 is in the form of a bore extending in a longitudinal direction through the first carriage body 19. The first aperture 43-1 has a central axis which is coincident with the central longitudinal axis X-1 of the first connecting rod 13-1. The first plunger 29-1 is moveable axially along the central longitudinal axis X-1, thereby enabling the first yoke 23-1 to move relative to the first carriage body 19. A seal is formed between the sidewall of the first plunger 29-1 and the first aperture 43-1. One or more seal may optionally be provided on the first plunger 29-1, for example in the form of a piston ring. An annular yoke biasing spring 47 is provided to apply a spring force to bias the first yoke 23-1 towards the advanced position. As described herein, the annular yoke biasing spring 47 is disposed between the first yoke 23-1 and the first connecting rod 13-1. The annular yoke biasing spring 47 in the present embodiment comprises one or more conical washer, such as one or more Belville washer. In a variant, the yoke biasing spring 47 comprises a wave spring or a resiliently deformable member.

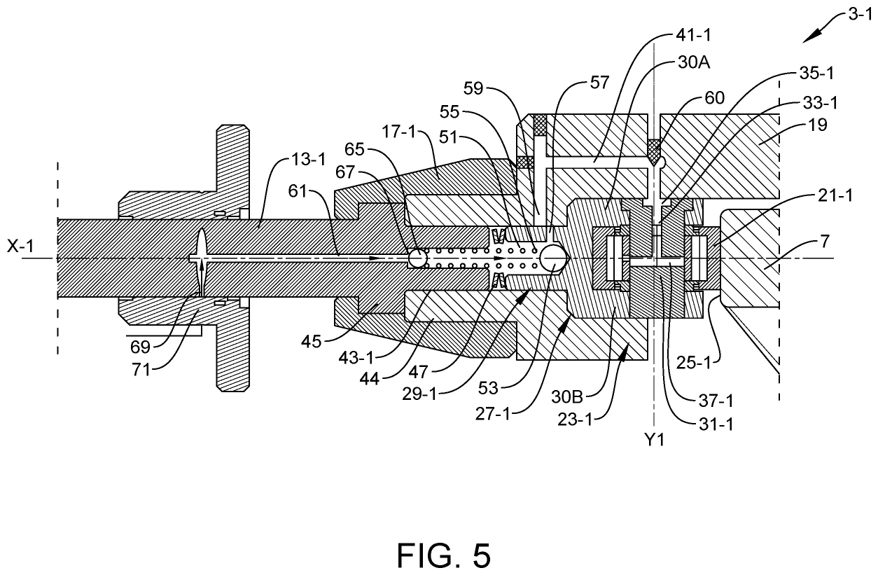

The first carriage assembly 3-1 is configured to reciprocate along the first longitudinal axis X-1 in unison with the first and second pistons 5-1, 5-2. In the present embodiment, the first carriage body 19 is fastened to the first and second pistons 5-1, 5-2 by first and second mechanical fasteners 17-1, 17-2. The mechanical fasteners 17-1, 17-2 in the present embodiment each comprise a rotary fastener. In particular, the mechanical fasteners 17-1, 17-2 each comprise a mounting nut having an internal thread for cooperating with an external thread provided on the first carriage body 19. The mounting arrangement of the first and second connecting rods 13-1, 13-2 is substantially the same and will now be described with reference to the first piston 5-1. A distal end of the first connecting rod 13-1 is located in the first aperture 43-1 formed in the first carriage body 19. The first carriage body 19 comprises an annular portion 44 having an external thread for receiving the mechanical fastener 17-1. As shown in FIG. 5, the first connecting rod 13-1 comprises a locating member 45 for fixing the axial position of the first connecting rod 13-1 relative to the first carriage body 19. The locating member 45 is configured to abut an end wall of the annular portion 44 of the first carriage body 19. The locating member 45 in the present embodiment is in the form of a collar 45 configured to abut an end wall of the annular portion 44. A gasket (not shown) may optionally be provided between the collar 45 and the first carriage body 19 to form a seal. The mechanical fastener 17-1 engages the collar 45 to fasten the first connecting rod 13-1 to the first carriage body 19. The mechanical fastener 17-1 is configured to cooperate with a tool, such as a wrench, to apply torque to fasten or unfasten the mechanical fastener 17-1. The mechanical fastener 17-1 comprises at least one pair of opposing faces arranged parallel to each other. The mechanical fastener 17-1 in the present embodiment has a hexagonal profile (in transverse section) comprising three of the pairs of opposing faces. A wrench or similar tool may engage the mechanical fastener 17-1 to apply a torque.

The first and second mechanical fasteners 17-n can be removed to enable removal of the first carriage assembly 3-1, for example to perform maintenance or servicing. One or more aperture AP-n is provided in the housing 11 to provide access to the carriage assemblies 3-n. In the present embodiment, one of the apertures AP-n is associated with each carriage assembly 3-n. A removable closure panel closure panel (not shown) is mounted to the housing 11 to close the aperture AP-n. As described herein, the closure panel can be removed for maintenance or servicing of the carriage assembly 3-n through the aperture AP-n. The aperture AP-n is sized to enable removal of the carriage assembly 3-n through the aperture AP-n when the closure panel is removed.

The position of the first yoke 23-1 relative to the first carriage body 19-1 is controlled by the supply of a hydraulic fluid through the first connecting rod 13-1. The hydraulic fluid may, for example, comprise an oil. In the present embodiment, the hydraulic fluid controls the position of the first yoke 23-1 relative to the carriage body 19 and is also supplied to the first bearing 21-1 (via the first carriage body 26-1) to provide lubrication. The first plunger 29-1 comprises a first chamber 51 which forms a portion of a hydraulic chamber for receiving the hydraulic fluid. The first chamber 51 comprises a blind hole formed along the central longitudinal axis X-1. A locating member 53, such as a ball, is provided in the first chamber 51 for locating a valve spring 55. An outlet port 57 is formed in the first yoke 17-1 for selectively discharging hydraulic fluid from the first chamber 51 into the first gallery 41-1 formed in the first carriage body 19. The outlet port 57 comprises a radial aperture in fluid communication with the first chamber 51. The first gallery 41-1 comprises a gallery inlet 59 which aligns with the outlet port 57 when the first yoke 23-1 is in a predetermined position relative to the first carriage body 19. In the present embodiment, the outlet port 57 is configured to align with the carriage gallery inlet 59 when the first yoke 23-1 is in the retracted position relative to the carriage body 19, as shown in FIG. 5. The outlet port 57 is not aligned with the carriage gallery inlet 59 when the first yoke 23-1 is advanced from the retracted position. For example, the outlet port 57 is not aligned with the carriage gallery inlet 59 when the first yoke 23-1 is in the fully advanced position, as shown in FIG. 3. The carriage gallery inlet 59 is thereby closed and the supply of hydraulic fluid to the first gallery 41-1 is inhibited. A flow control device 60 is provided to control the supply of the hydraulic fluid from the first gallery 41-1 to the first bearing 21-1. In the present embodiment, the flow control device 60 comprises a bleed screw.

The first connecting rod 13-1 comprises a supply conduit 61 for supplying the hydraulic fluid to the first chamber 51. A non-return valve 63 prevents the return of hydraulic fluid through the supply conduit 61. The non-return valve 63 in the present embodiment is a ball valve comprising a ball 65 and a valve seat 67. Other types of valve, such as a poppet valve, could be used in the non-return valve 63. The valve spring 55 biases the ball 65 towards the valve seat 67 to close the supply conduit 61. The supply conduit 61 comprises an inlet aperture 69 which is selectively placed in communication with an engine supply port 71 connected to a high-pressure oil supply, such as an engine oil gallery. The inlet aperture 69 of the supply conduit 61 is placed in fluid communication with the engine supply port 71 when the first connecting rod 13-1 is in a predetermined position(s). In the present embodiment, the inlet aperture 69 is placed in fluid communication with the high-pressure oil supply when the first piston 5-1 or is disposed at the top dead centre (TDC) position.

The operation of the carriage assemblies 3-n are at least substantially the same as each other, albeit out of phase with each other. The operation of the first carriage assembly 3-1 during normal operation of the swash plate engine 1 will now be described with reference to FIGS. 2, 3 and 4.

The carriage assembly 3-n is shown with the first piston 5-1 in a fully retracted position in FIGS. 2, 3 and 5 corresponding to the top dead centre (TDC) position. In this configuration, the inlet aperture 69 is open to the engine supply port 71 and hydraulic fluid is introduced at high pressure into the supply conduit 61 formed in the first connecting rod 13-1. The hydraulic fluid is supplied at sufficient pressure to overcome the valve seat pressure applied by the valve spring 55, thereby unseating the ball 65 and opening the non-return valve 63. The hydraulic fluid is supplied via the engine supply port 71 to the first chamber 51 formed in the first yoke 23-1. The hydraulic fluid displaces the first yoke 23-1 to the fully advanced position relative to the carriage body 19. The outlet port 57 is out of alignment with the carriage gallery inlet 59 in this configuration such that the outlet from the first chamber 51 is closed, as shown in FIG. 3. The hydraulic fluid is introduced into the first chamber 51. The first plunger 29-1 is advanced, thereby displacing the first yoke 23-1 forwards relative to the first carriage body 19. The hydraulic fluid displaces the first yoke 23-1 to the fully advanced position relative to the carriage body 19. The first bearing 21-1 is displaced towards the first rolling face 25-1 of the swash plate 7.

When the first connecting rod 13-1 is advanced form the TDC position, the inlet aperture 69 is moved out of alignment with the engine supply port 71. The supply of hydraulic fluid to the supply conduit 61 is stopped. The valve spring 55 biases the ball 65 towards the valve seat 67 and closes the non-return valve 63. The outlet port 57 is not aligned with the carriage gallery inlet 59 and the first chamber 51 is at least substantially sealed. The hydraulic fluid within the first chamber 51 is held at pressure by the non-return valve 63. The first yoke 23-1 is hydraulically held in position (relative to the carriage body 19) by the pressure of the hydraulic fluid in the first chamber 51.

As the first connecting rod 13-1 reaches the end of its stroke (corresponding to a bottom dead centre (BDC) position), the change in momentum of the first connecting rod 13-1 sets up a deceleration force on the first yoke 23-1. As shown in FIG. 6, the first yoke 23-1 is displaced relative to the first carriage body 19 under load and the change in the volume of the first chamber 51 forces the hydraulic fluid through the outlet port 57 into the first gallery 41-1 formed in the first carriage body 19. The hydraulic fluid is pumped through the first gallery 41-1 and into the first bearing 21-1. The hydraulic fluid is used to lubricate the first bearing 21-1. The rate that the hydraulic fluid is bled from the cavity determines the deceleration force acting on the first yoke 21-1. The bleed valve 60 can be adjusted to control the deceleration force acting on the first yoke 21-1. The yoke biasing spring 47 is compressed under the load in the last section of the travel of the first yoke 23-1.

At least in certain embodiments, the release of the hydraulic fluid from the first chamber 51 is effective in delaying the instantaneous change of momentum. This may decrease loading on the first yoke 23-1, for example to reduce the peak load applied to the first bearing 21-1. Furthermore, any gap between the first bearing 21-1 and the swash plate 7 can be maintained to a very small value. This may reduce manufacturing tolerances for components in the first carriage assembly 3-1, such as the first carriage body 19. By dynamically adjusting the axial position of the first yoke 23-1, the first carriage assembly 3-1 may allow for wear of the first bearing 21-1 and/or the first rolling face 25-1 of the swash plate 7.

The swash plate engine 1 according to the present embodiment may require servicing or maintenance. For example, a piston ring on one of the pistons 5-n may need to be replaced. Advantageously, the swash plate engine 1 can be serviced without requiring a complete disassembly of the housing 11. The closure panel(s) mounted on the housing 11 is removed to open one or more of the apertures AP-n. The aperture AP-n provides the operator with access to an associated one of the carriage assemblies 3-n. The mechanical fasteners 17-1, 17-2 fastening the first and second pistons 5-1, 5-2 to the carriage body 19 may be released. The cylinder heads 12-n may be removed from the housing 11. After releasing the connecting rods 13-1, 13-2 from the carriage body 19, the first and second pistons 5-1, 5-2 may be removed through the opposing ends of the swash plate engine 3. Thus, servicing or maintenance of the pistons 5-n and the carriage assemblies 3-n may be performed with the body 11 in place. The assembly of the swash plate engine 3 can be performed by performing the same operations in the reverse order.

It will be understood that the second, third and fourth carriage assemblies 3-2, 3-3, 3-4 undergo at least substantially the same operating cycle. The operation of the pistons 13-n is controlled to maintain operation of the swash plate engine 3 in known manner.

The first and second bearings 21-1, 21-2 in the above embodiment each comprise a yoke track roller. An alternative bearing arrangement for the first and second bearings 21-1, 21-2 will now be described with reference to FIGS. 6 and 7. The bearing arrangement will be described with reference to the first bearing 21-1, but it will be understood that the second bearing 21-2 has at least substantially the same configuration. The first bearing 21-1 is mounted in a modified version of the first yoke 23-1 and the changes in the configuration of the yoke 23-1 will also be described. It will be understood that the first bearing 21-1 and/or the first yoke 23-1 may be used in the carriage assembly 3-n described in the above embodiment of the present invention. Like reference numerals are used for like components.

A plan view of the first yoke 23-1 and the first bearing 21-1 is shown in FIG. 7. A longitudinal sectional view along the section line A-A of FIG. 7 is shown in FIG. 8. The first bearing 21-1 comprises a spindle 75, an inner race 77, an outer race 79 and rolling elements 81. The spindle 75 is hollow and comprises one or more bearing lubrication channel 33-1 operative to supply a lubricant to the rolling elements 81. As described herein, the bearing lubrication channel 33-1 is configured to receive lubricant from the first carriage 41-1 (not shown in FIG. 7). The bearing lubrication channel 33-1 comprises a lubricant supply port 35-1 for receiving lubricant; and two first bearing outlet ports 37 for delivering the lubricant to the rolling elements 81. The bearing outlet ports 37 are diametrically opposed from each other in the present embodiment. The rolling elements 81 are arranged in first and second rows 83-1, 83-2. The first and second rows 83-1, 83-2 are arranged such that the central axis of the rolling elements 81 are inclined relative to each other in a V-shaped configuration. The rolling elements 81 in the present embodiment comprise tapered bearings, but other types of bearings may be employed. For example, the rolling elements 81 may comprise cylindrical bearings. The outer race 79 is a hardened roller race comprising an inner surface 85 for engaging the rolling elements 81; and an outer surface 87 for engaging the first rolling face. The inner surface 85 is profiled at least substantially to match the profile of the rolling elements 81 disposed in the first and second rows 83-1, 83-2. As shown in FIG. 7, the inner surface 85 is convex. This arrangement may promote alignment of the inner and outer races 77, 79. Alternatively, or in addition, sideways (lateral) loading on the first yoke 23-1 and/or the piston face may be reduced or eliminated. The first bearing 21-1 is suitable for high-speed use in the swash cam engine 1 and, at least in certain embodiments, may provide improved durability, for example when exposed to high impact loads. The second bearing 21-2 may have at least substantially the same configuration.

The first yoke 23-1 comprises first and second arms 30A, 30B arranged to support the spindle 75 of the first bearing 21-1. The first yoke 23-1 comprises one or more linear guide 87 for maintaining the axial alignment of the first yoke 23-1. The one or more linear guide 87 extend parallel to the longitudinal axis X-1 of the first yoke 23-1. The first yoke 23-1 shown in FIG. 8 comprises first and second linear guides 87-1, 87-2 disposed on opposing ends of the second arm 30A. The first and second linear guides 87-1, 87-2 project from the first arm 30A and locate in respective first and second channels (not shown) formed in the first carriage body 19. The first and second linear guides 87-1, 87-2 travel within the first and second channels as the first yoke 23-1 moves relative to the first carriage body 19. It will be understood that the first yoke 23-1 may comprise a single guide 87-n or more than one guide.

It will be appreciated that various changes and modifications can be made to the present invention without departing from the scope of the present application.

The carriage assembly 3-1 described herein comprises first and second bearings 21-1, 21-2 which are moveable relative to the carriage body 19. In particular, the first and second yokes 23-1, 23-2 are moveable along a longitudinal axis. In a variant, the carriage body 19 may comprise first and second body portions (not shown) which are moveable axially relative to each other. The first and second yokes 23-1, 23-2 may be mounted to the first and second body portions in a fixed arrangement which inhibits or suppresses relative movement. In this arrangement, the relative movement of the first and second body portions may be controlled to reduce dynamic loading of the first and second bearings 21-1, 21-2. A hydraulic chamber may be provided to control movement of the first and second body portions relative to each other.

1-21. (canceled)

22. A swash plate drive assembly for a swash plate engine, the swash plate drive assembly comprising:
a carriage body for reciprocating along a longitudinal axis; and
at least one piston for displacing the carriage body along the longitudinal axis; and
wherein the at least one piston is connected to a connecting rod, the connecting rod being releasably fastened to the carriage body by one or more mechanical fastener.

23. A swash plate drive assembly as claimed in claim 22, wherein the at least one connecting rod comprises at least one locating member, the at least one locating member being configured to engage the carriage body.

24. A swash plate drive assembly as claimed in claim 23, wherein the at least one locating member extends at least partway around a circumference of the connecting rod.

25. A swash plate drive assembly as claimed in claim 24, wherein the mechanical fastener comprises one or more shoulder, the one or more shoulder engaging the at least one locating member to inhibit movement of the connecting rod relative to the carriage body.

26. A swash plate drive assembly as claimed in claim 25, wherein the or each mechanical fastener comprises a rotary fastener for releasably fastening the connecting rod to the carriage body.

27. A swash plate drive assembly as claimed in claim 26, wherein the rotary fastener is rotatable about the longitudinal axis.

28. A swash plate drive assembly as claimed in claim 27, wherein the rotary fastener comprises an annular member having a central aperture, the connecting rod extending through the central aperture.

29. A swash plate drive assembly as claimed in claim 26, wherein the rotary fastener comprises an internal thread for cooperating with an external thread formed on the carriage body.

30. A swash plate drive assembly as claimed in claim 29, wherein the rotary fastener comprises at least one pair of opposing faces for cooperating with a wrench to apply a torque.

31. A swash plate drive assembly as claimed in claim 30, wherein a distal end of the or each piston is disposed in an aperture formed in the carriage body, the aperture extending along the longitudinal axis.

32. A swash plate drive assembly as claimed in claim 30, comprising at least one bearing assembly for engaging a swash plate in the swash plate engine.

33. A swash plate drive assembly as claimed in claim 30, wherein the connecting rod is releasably connected to the piston.

34. A swash plate drive assembly as claimed in claim 30, wherein the at least one piston comprises first and second pistons, the first and second pistons being releasably connected to the carriage body.

35. A swash plate drive assembly as claimed in claim 34, wherein the first and second connecting rods are releasably connected to opposite ends of the carriage body.

36. A swash plate engine comprising at least one carriage assembly as claimed in claim 22.

37. A swash plate engine as claimed in claim 36, comprising a housing, the at least one carriage assembly being disposed in the housing.

38. A swash plate engine as claimed in claim 37, wherein the housing comprises one or more aperture for accessing the at least one carriage assembly.

39. A swash plate engine as claimed in claim 38, wherein the one or more access aperture is sized to enable the carriage body to be removed from the swash plate engine through the access aperture.

40. A connecting rod for a swash plate engine, the connecting rod having a first end for connecting to a piston; and a second end for connecting to a carriage body of the swash plate engine;
wherein the connecting rod comprises at least one locating member for cooperating with a mechanical fastener releasably to fasten the connecting rod to the carriage body.

41. A connecting rod as claimed in claim 40, wherein the at least one locating member extends at least partway around a circumference of the connecting rod.
